(19) United States
(12) Patent Application Publication
(10) Pub. No.: US 2022/0245639 A1
(43) Pub. Date: Aug. 4, 2022

(54) Virtual Fraud Detection

(71) Applicant: Bottomline Technologies (de) Inc., Portsmouth, NH (US)

(72) Inventor: Peter Cousins, Rye, NH (US)

(73) Assignee: Bottomline Technologies (de) Inc., Portsmouth, NH (US)

(21) Appl. No.: 16/246,076

(22) Filed: Jan. 11, 2019

(51) Int. Cl. G06Q 20/40; G06K 9/62; G06F 16/951; G06F 17/27; H04L 29/06

(52) U.S. Cl. CPC G06Q 20/4016; G06K 9/6267; G06F 16/951; H04L 61/1511; H04L 63/126; H04L 63/1466; G06F 17/27

(57) ABSTRACT

A virtual fraud detection system and method is described for the real time processing of banking transactions seen on a banking rail. The transaction is processed through natural language processing to determine who the parties are, and natural language processing is performed on the web site and the social media pages of employees to ascertain if the originator and the beneficiary of the transaction make sense. In addition, the age of the DNS records of the parties is checked to see if the parties are established organizations.

### BACKGROUND

### Prior Application

This application is a priority application.

### Technical Field

The system, apparatuses and methods described herein generally relate to the detection of fraudulent financial transactions and specifically to techniques for automatically identifying fraudulent transactions using web based virtual investigations.

### Description of the Related Art

The earliest history of fraud is found in the Greek literature, and history includes Numerous schemes and tactics from taking money from others using deceptive means. On article in Forbes Magazine set the amount of money lost to fraud at $190 Billion per year in 2009, with banks absorbing $11 Billion, consumers taking a $4.8 Billion hit, and merchants absorbing the rest. The sheer magnitude of the money lost to fraud has forced banks to place an increasing emphasis on fraud detection.

Today, banking fraud is a sophisticated global business. Cyber criminals are organized, coordinated, and highly specialized, thus creating a powerful network that is, in many ways, a significantly more efficient ecosystem than the banking industry. They continually reinvest their financial gains to advance technology and methods they use to defeat the layers of security financial institutions put in place.

The pace of fraud innovation by fraudsters and their ability to invest in attacking banks and credit unions far outweigh these institutions abilities to invest in protecting themselves against rapidly evolving threats. Whether its phishing scams, mobile malware, banking Trojans, Man-In-the-Browser schemes, or the many techniques for bypassing multi-factor authentication, threats span online banking, mobile banking, as well as the ACH and wire payments channels. The range and sophistication of the threats against which financial institutions must defend themselves continues to grow.

The traditional approach to fraudulent activities is to manually analyze historical transactions looking for patterns or for transactions that are out of line with the norm. But these methods fail to prevent fraudulent activities, instead, they only serve to disclose what happened in the past. And the sheer volume of transactions prevents the review of more than a small sampling of the overall transaction set.

There is a long felt need to automatically review and identify potentially fraudulent transactions in real time as the transactions cross the rail. The present invention overcomes this shortcoming of the existing art.

### BRIEF SUMMARY OF THE INVENTION

A special purpose computing apparatus for detection of the real time detection of fraud on a banking rail is described herein. The apparatus is made up of at least one network interface electrically connected to a the banking rail, a number of processing cores electrically connected to the network interfaces, and a storage subsystem electrically connected to the processing cores. At least one of the network interfaces receives a transaction from the banking rail and passes the transaction to the processing cores. The processing cores, using natural language processing on the transaction, on the web page for the transaction originator and the web page for the transaction receiver, determines a set of industry classifications for the originator and a set of industry classifications for the receiver. If the industry classification set for the originator does not overlap with the industry classification set for the receiver, the processor cores send the transaction for further review.

The further review could be performed by an automaton in one embodiment. The processing cores could pipeline the analysis of the transactions or in another embodiment the cores could analyze the transactions in parallel. The processing cores could check the date of a domain name server (DNS) record for the receiver (or the originator) and send the transaction for further review if the date is less than a predetermined value. The processing cores could check social media sites for employees of the originator (or receiver) and send the transaction for further review if no employees are found on social media. The processing cores could perform natural language processing on the social media sites for the employees of the originator (or receiver) to create a set of employee related industry classifications and send the transaction for further review if the sets of employee related industry classifications do not overlap with the set of classifications of the receiver.

A virtual method for detecting fraud from a stream of transactions on a banking rail is also described. The method is made up of the steps of receiving a transaction from the banking rail, executing natural language processing on the transaction to determine a receiver web page associated with a receiving party of the transaction, determining a set of receiver industry classifications by performing natural language processing on the receiving party web page, executing natural language processing on the transaction to determine an originator web page associated with an originating party of the transaction, determining a set of originator industry classifications by performing natural language processing on the originating party web page, and sending the transaction to additional review if the set of originator industry classifications do not overlap the set of receiver industry classifications.

The further review could be performed by an automaton. The method could further comprise checking a date of a domain name server record for the receiver (or originator) and sending the transaction for further review if the date is less than a predetermined value. The method could further include the steps of checking social media sites for employees of the originator (or receiver) and sending the transaction for further review if no employees are found on social media. The further steps could also include natural language processing on the social media sites for the employees of the originator (or receiver) to create a set of employee related industry classifications and sending the transaction for further review if the sets of employee related industry classifications do not overlap with the set of classifications of the receiver.

### BRIEF DESCRIPTION OF THE DRAWINGS

FIG. 1 illustrates the transaction flow from one bank, through the fraud detection server to the receiving bank.

FIG. 2 shows the process flow of a transaction through the software on the fraud detection server.

FIG. 3 shows a flow chart of the virtual investigation.

FIG. 4 illustrates a possible hardware configuration for implementing the virtual fraud detection.

### DETAILED DESCRIPTION

In the detection of fraud in banking transactions, the automatic detection and flagging of suspicious transactions is important. Any particular bank may have tens or hundreds of thousands of transactions to review. While there are currently a number of fraud detection products on the market, there are no products that conduct a natural language review of the text of the transaction to see if the transaction “makes sense”. The present inventive solution makes use of natural language processing to convert the text into an identifiable industry classification. Once the industry classification is determined, a virtual investigation is conducted to see if the transaction is legitimate.

In one embodiment, the present solution is applied to wire or ACH transactions on the banking rail. In another embodiment, the present solution is applied to automatic bank account openings and reviewing the information using natural language processing to see if the information “makes sense” to virtual investigation software.

For example, a government energy department has a bank account. If this account attempts to move a large sum money to a small stationary store, the transaction is flagged for further review. This is because of the mismatch between the industry classifications of the two businesses. If the account is used to send money to an energy company, the transaction is allowed at one level, because it is expected that the two companies would be doing business. Next, the receiving energy company is automatically checked via the web. Does their web site discuss energy 302? How old is the Domain Name Service (DNS) record for the company 304? Are the LinkedIn records for the employees related to energy 305?

A recently filed DNS record indicates an organization that may not be established 304, suggesting that it should be investigated further. If the web site or the social media records for the employees do not match the expected industry classification 305 after the natural language processor reviews the content, then there may be an issue with the transaction that needs further analysis.

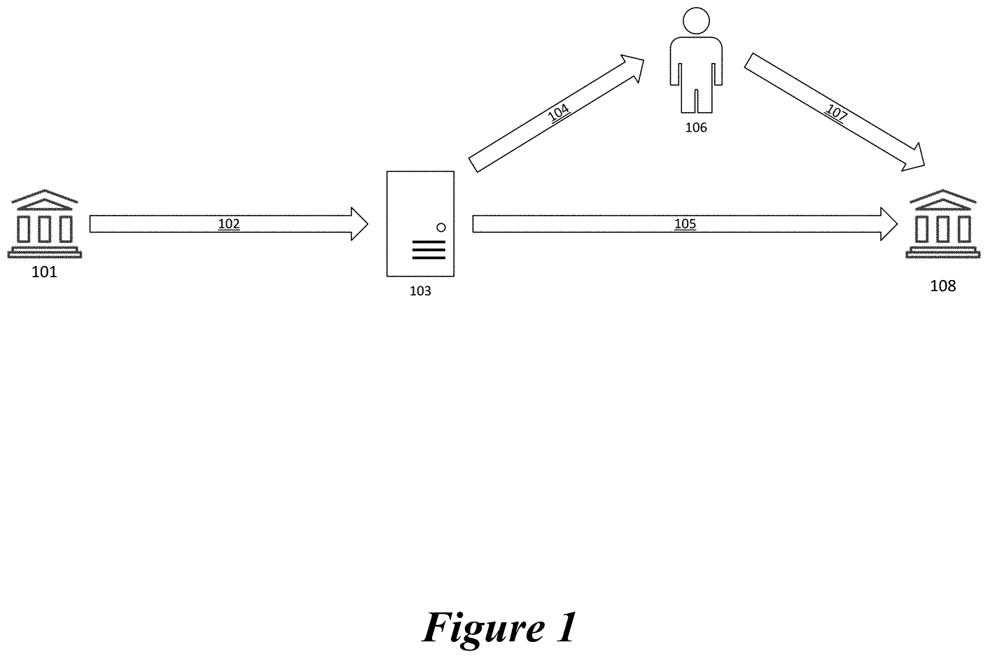

Starting with FIG. 1, the banking rail 102, 105 moves financial transactions from the source bank 101 to the receiving bank 108. The banking rail 102, 105 could be a network, such as an Ethernet network or the Internet. In most embodiments, the banking rail is a secure, encrypted channel for the banking transactions, although other networking structures could be used. In some embodiments, the rail 102, 105, 107 could be the same physical network, and could also be the same physical network as the internet 404 and the network to send questionable transactions 104.

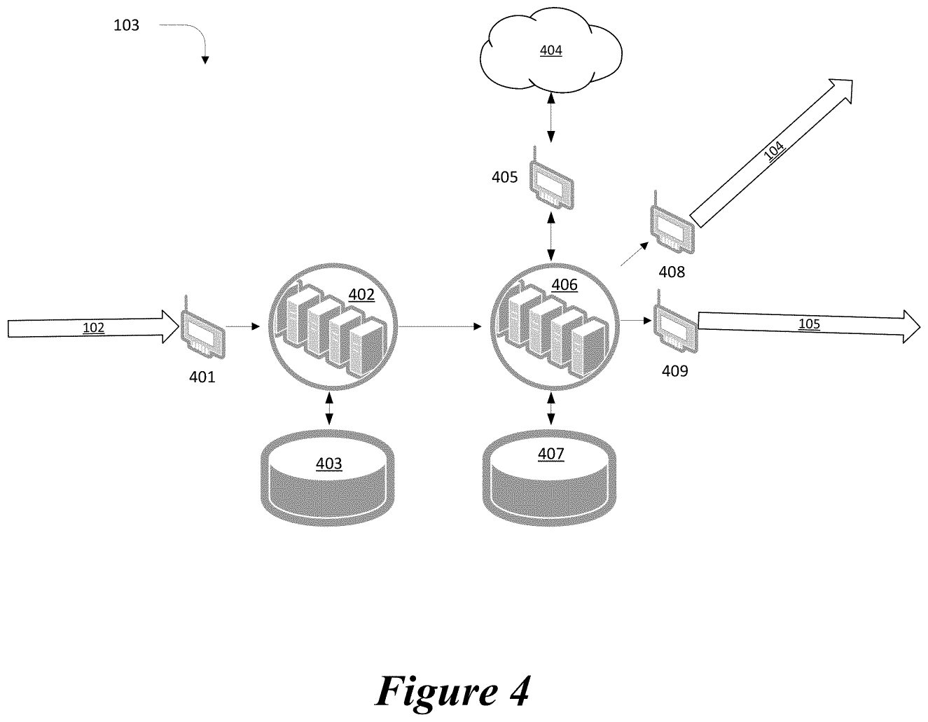

In the middle of the banking rail 102, 105 is a fraud detection server 103. This server 103 is a special purpose computing platform with one or more high speed network interfaces for rapidly moving packets related to the financial transactions into the server for review and back out to the rail 105 for delivery to the receiving bank 108. The server 103 could have a high performance set of processing cores 402,403 for analyzing multiple transactions simultaneously. In addition the server 103 could be equipped with a large memory store 403,407 for keeping data required for the high performance natural language processing of the transactions. Furthermore, caching of previously identified acceptable relationships may be used to increased throughput. In one embodiment the server 103 is designed with one bank of processing cores reviewing the natural language processing aspects of the present inventions 402, and then sending the parsed transaction to a bank of virtual cores to perform the virtual fraud investigating 406. See FIG. 4 for further details of one set of embodiments of a server 103 architecture.

When the server 103 detects a questionable transaction, it is not placed back on the banking rail 105, but instead it is sent for additional review by a reviewer 106 through a network 104 (this could be the same physical network as the rail 102, 104, 105, 107 in some embodiments). If the reviewer 106, after looking over the transaction, finds it acceptable, the transaction is returned to the banking rail 107 for delivery to the receiving bank 108. If the reviewer 106 does not approve the transaction, if is either thrown out or it is returned to the receiving bank 101 as a rejected transaction. The reviewer 106 could be a human or a more advanced automaton with deeper analysis capabilities to review the transaction in more detail. Typically, the reviewer 106 works much slower than the speeds that the server 103 operates.

While this embodiment has a separate fraud detection server 103, other embodiments have the software described herein operating on the computers at the originating bank 101 or the receiving bank 108.

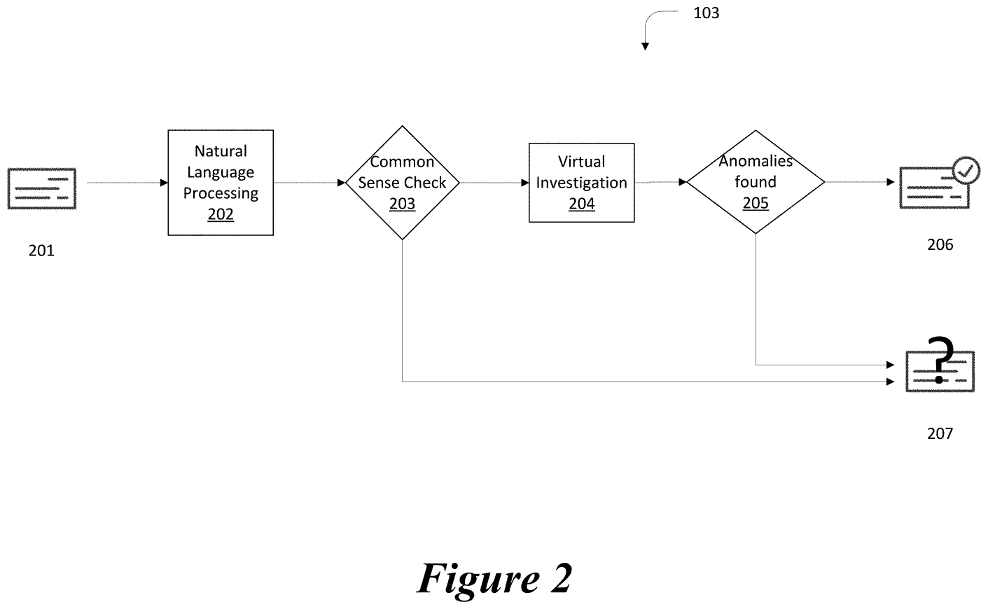

Turning to FIG. 2, the transaction flow through the server is documented as it operates in the server 103. The transaction 201 could be a wire in the SWIFT MT100 format, an ACH record in the NACHA format, a Real Time Payment formatted message or similar transaction. In some embodiments, the transaction 201 is a set of information for opening a bank account.

The transaction 201 flows into the natural language processing 202 code that determines a set of industry classifications of the sending and receiving parties. The natural language processing 202 will use the name of the parties, their addresses, phone numbers, email addresses and any other information in the message comments fields to determine a set of classifications for each party.

Once the set of classifications of the parties is determined, a common sense check 203 is performed on the industry classifications. The classifications are compared to see if they are compatible. Is the government department of energy sending large sums of money to an energy company? If the company is not in energy, flag the transaction. Is a steel company sending large sums of money to a granite company? Perhaps this transaction needs additional review, but a large payment to an ore company “makes sense” to the software. The heuristics in this analysis, in some embodiments, involves a table lookup of compatible transaction pairs. For rejected pairs, the transaction is marked as a questionable transaction 207 and sent to the reviewer 106 for further analysis. If the pair is found to be compatible, the reviewer 106 may add that back into the list of acceptable transactions, essentially teaching the machine to learn which transactions are allowable. In other cases, the reviewer 106 may determine that while this transaction is acceptable, similar, future transactions should be reviewed.

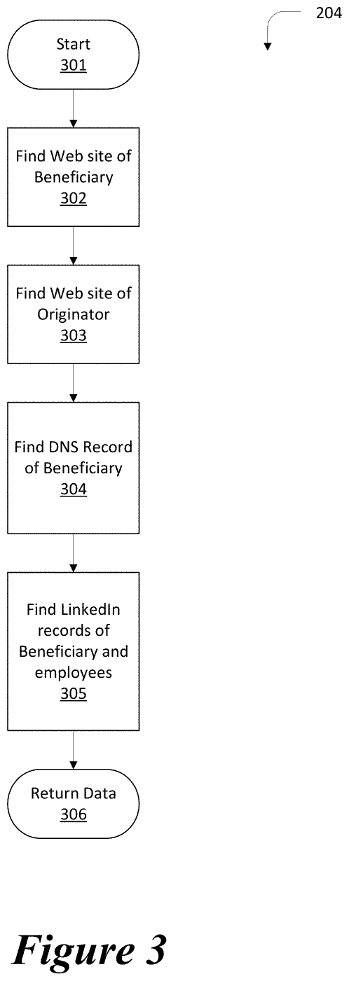

If the transaction 201 passes the common sense check 203, a virtual investigation 204 is then performed on the receiving party to the transaction. This virtual fraud investigation 204 is shown in FIG. 3.

If the virtual fraud investigation 204 identifies an anomaly 205, the transaction is marked as questionable 207 and sent to the reviewer 106. If no anomalies are found 205, the transaction is considered acceptable 206, and is sent onto the rail 105 for delivery to the receiving bank 108.

FIG. 3 shows one embodiment of the virtual fraud investigation 204. This investigation 204 does a rapid, real time check to see if the receiver and originator are who is claimed. Several checks are listed here, but others could be included without detracting from the invention. Furthermore, different embodiments could use any combination of the listed checks as needed.

After starting 301 the process, the first step in this embodiment is to find the web site of the receiving party 302. In a SWIFT MT100 transaction, the beneficiary name and optionally the beneficiary email address is available. Additional information may be in the optional payment details fields. Natural language processing is performed on these field to determine the web site address of the receiver. If the email address is present, then the determination of the web site is easily found by parsing the email address. Otherwise, the web is searched for the name.

An NACHA formatted transaction has less information to work with. The receiver's name is present, and some information may be in the discretionary data. Natural language processing is performed on these field to determine the web site address of the receiver.

Once the website is determined, a natural language processing algorithm is performed on the web site to determine a set of industry classifications of the receiver. This set of classifications is compared to the receiver's classifications in the last step. Often, the classification is not a single value but a set of classifications as the company has multiple lines of business. If it does not match, the record is flagged as an anomaly. In one embodiment, an anomaly counter is set to zero at the start 301 to the virtual investigation process 204. The anomaly counter is incremented when the classifications of the receiving party do not overlap. In another embodiment, the investigation stops after an anomaly is found, the transaction is marked as questionable 207, and the transaction is sent to the reviewer 106 for further analysis.

A similar analysis is done on the originating party 303. If the originating party classification set does not overlap that determined in the natural language processing 202, then the transaction is marked as an anomaly, perhaps by incrementing the anomaly counter or by immediately marking the transaction as questionable 207.

Next, the domain name service (DNS) record of the receiver is retrieved over the web 304 using a whois search (or similar). The creation date in the DNS record is checked to see if the domain was registered recently. The determination of how recently is acceptable is a preset parameter that could be updated through machine learning. If the creation date is recent, the transaction is marked as an anomaly by incrementing the anomaly counter or by immediately marking the transaction as questionable 207. In some embodiments, the DNS record for the originating party's web site is also checked to see when the URL was created.

Finally, the social media records of employees of the receiving party are checked to see if they are related to the industry classifications 305. This is done by searching LinkedIn, Facebook, or similar social media sites for a list of employees claiming to be employed by the receiving company. A sampling of the employee's social media pages are processed through a natural language processing algorithm to extract a set of industry classifications from the social media pages. This set is then compared to the set of industry classifications found in 202. If the receiving party classification set does not overlap that determined in the natural language processing 202, then the transaction is marked as an anomaly, perhaps by incrementing the anomaly counter or by immediately marking the transaction as questionable 207. If no receiving party employees are found on social media, the transaction is also considered an anomaly.

A similar check of the social media pages of the originator's employees could be done.

Once virtual investigation is complete, the data is returned 306, either as an anomaly counter or as a Boolean indicating whether an anomaly was found.

FIG. 4 shows one embodiment of a computing configuration for conducting the virtual fraud detection 103. The banking rail 102 sends transactions 201 in for form of network packets to a receiving network interface card (or chip or section of a semiconductor) 401. The network interface 401 assembles packets into a transaction 201, and sends the entire transaction 201 to one of a first set of processing cores 402 for execution of the natural language processing 202 process and the common sense check 203. The first set of cores 402 uses the storage area (could be a combination of RAM, cache, and longer term storage such as disk drives and solid state drives) 403 to hold the data needed for analyzing the transaction 201. The first processing cores 402 could be a single core for all transactions, or could use one core per transaction.

Once the common sense check 203 is complete, the transaction 201 is sent to the second set of processing cores 406 to perform the virtual investigation 204. The second set of processing cores 406 interfaces with its storage area (could be a combination of RAM, ROM, cache, and longer term storage such as disk drives and solid state drives) to store data associated with the transaction 201. The second set of processing cores 406 interface with network interface 405 to access the internet 404 for the retrieval of web sites, DNS records, social media pages etc. needed for the virtual fraud investigation 204. In some embodiments, a set of processing cores could be assigned to each task outlined in FIG. 3: investigating web sites 302, 303, checking DNS records 304, checking social media pages 305. In this embodiment, the transaction 201 is handled through pipelined processing. In another embodiment, there is a single set of processing cores, with each core handling the entire processing of a transaction 201, as in parallel processing.

Once the second set of processing cores 406 completes the transaction 201 processing, the transaction is either sent to the network interface 408 for transmission to the network 104 to the reviewer 106, or the transaction 201 is sent to network interface 409 for transmission to the banking rail 105. In some embodiments, the network interfaces 401, 405, 408, 409 could be combined in any combination into a single or multiple network interfaces.

The first set of processing cores 402 are electrically (or optically) connected to the network interface 401 and the storage 403. The two processing cores 402, 406 are electrically or optically connected. The second processing core 406 is electrically (or optically) connected with storage 407 (note that in some embodiments, storage 403 and storage 407 are the same or are connected). The second processing core 406 is electrically (or optically) connected with network interfaces 405, 408, 409.

In the account opening embodiment, rather than transactions entering into the process described herein, account opening requests are received and analyzed through the virtual investigation process 204. Of course, there is no “receiver” to analyze, but the party opening the bank account is often required to specify an industry classification, and that is used to compare to the web page 303 and social media page 305 industry classification sets as determined by the natural language processing.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A special purpose computing apparatus for real time detection of fraud on a banking rail, the apparatus comprising:
at least one network interface electrically connected to the banking rail, where the banking rail uses a secure, encrypted channel;
a plurality of processing cores electrically connected to the at least one network interface; and
a storage subsystem electrically connected to the plurality of processing cores,
wherein at least one of the network interfaces receives a transaction from the banking rail and passes the transaction to the processing cores,
wherein the processing cores, using natural language processing on the transaction and on a web page for an originator of the transaction and a web page for a receiver of the transaction, determines a set of industry classifications for the originator and a set of industry classifications for the receiver, and sends the transaction for further review if the industry classification set for the originator does not overlap with the industry classification set for the receiver.

2. The apparatus of claim 1 wherein the further review is performed by an automaton.

3. The apparatus of claim 1 wherein the processing cores pipeline analysis of the transactions.

4. The apparatus of claim 1 wherein the processing cores analyze the transaction in parallel.

5. The apparatus of claim 1 wherein the processing cores check a date of a domain name server record for the receiver and sends the transaction for the further review if the date is less than a predetermined value.

6. The apparatus of claim 1 wherein the processing cores check a date of a domain name server record for the originator and sends the transaction for the further review if the date is less than a predetermined value.

7. The apparatus of claim 1 wherein the processing cores check social media sites for employees of the originator and sends the transaction for the further review if no employees are found on social media.

8. The apparatus of claim 7 wherein the processing cores perform natural language processing on the social media sites for the employees of the originator to create a set of employee related industry classifications and send the transaction for the further review if the sets of employee related industry classifications do not overlap with the set of classifications of the receiver.

9. The apparatus of claim 1 wherein the processing cores check social media sites for employees of the receiver and sends the transaction for the further review if no employees are found on social media.

10. The apparatus of claim 9 wherein the processing cores perform natural language processing on the social media sites for the employees of the receiver to create a set of employee related industry classifications and send the transaction for the further review if the sets of employee related industry classifications do not overlap with the set of classifications of the originator.

11. A virtual method for detecting fraud from a stream of transactions on a banking rail, the method comprising:
receiving a transaction from the banking rail, where the banking rail uses a secure, encrypted channel for transactions;
executing natural language processing on the transaction to determine a receiver web page associated with a receiving party of the transaction;
determining a set of receiver industry classifications by performing natural language processing on the receiving party web page;
executing natural language processing on the transaction to determine an originator web page associated with an originating party of the transaction;
determining a set of originator industry classifications by performing natural language processing on the originating party web page;
sending the transaction to additional review if the set of originator industry classifications do not overlap the set of receiver industry classifications.

12. The method of claim 11 wherein the additional review is performed by an automaton.

13. The method of claim 11 further comprising
checking a date of a domain name server record for the receiver and
sending the transaction for the additional review if the date is less than a predetermined value.

14. The method of claim 11 further comprising
checking a date of a domain name server record for the originator and
sending the transaction for the additional review if the date is less than a predetermined value.

15. The method of claim 11 further comprising
checking social media sites for employees of the originator and
sending the transaction for the additional review if no employees are found on social media.

16. The method of claim 15 further comprising
natural language processing on the social media sites for the employees of the originator to create a set of employee related industry classifications and
sending the transaction for the additional review if the sets of employee related industry classifications do not overlap with the set of classifications of the receiver.

17. The method of claim 11 further comprising
checking social media sites for employees of the receiver and
sending the transaction for the additional review if no employees are found on social media.

18. The method of claim 17 further comprising
natural language processing on the social media sites for the employees of the receiver to create a set of employee related industry classifications and
sending the transaction for the additional review if the sets of employee related industry classifications do not overlap with the set of originator industry classifications.
